(19) United States
(12) Patent Application Publication
(10) Pub. No.: US 2006/0080224 A1
(43) Pub. Date: Apr. 13, 2006

(54) Method for dynamically initiated interactive group communications

(75) Inventors: Anett Schuelke, Heidelberg (DE); Marcus Kuhnen, Heidelberg (DE); Arabella Riu, Heidelberg (DE); Miquel Martin, Heidelberg (DE); Amjad Akkawi, Heidelberg (DE); Florian Winkler, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/226,410

(22) Filed: Sep. 15, 2005

(30) Foreign Application Priority Data
Oct. 11, 2004 (DE) 10 2004 049 711.7

(51) Int. Cl. G06Q 40/00

(52) U.S. Cl. 705/37

(57) ABSTRACT

A method for dynamically initiated interactive group communication between several participants concerning a process offered by an organizer includes: definition and conditioning of the process according to parameters that can freely be defined by the organizer, selection of the resource(s) to display the process, definition of target persons or groups and call by the organizer for participation/registration, registration by interested persons, acceptance of the registration and definition of group of participants according to criteria which can be pre-set by the organizer, start of the interactive communication depending on the organizer, on one or more participants or on an event, specification of a process content, enforcement of the interactive communication with regard to the communication rules and completion of the communication when reaching a result which is defined or can be defined or influenced by the organizer or by one or more participants in the course of the communication.

### BACKGROUND OF THE INVENTION

1. Field of the Invention

The present invention relates to a method for dynamically initiated interactive group communication between several participants regarding a process offered by an organizer.

2. Description of the Related Art

Methods of the above mentioned kind can be used in very different fields whenever a process requires an interactive group communication that can in addition be dynamically initiated. The case of the process offered could be a mobile auction or maybe a medical emergency in which a surgical team invites other specialists for a professional consultative participation.

In principle, the present method is a method for group communication which can be used for a wide range of fields and where a dynamical initiation takes place and which can be performed for a major portion online and for a minor portion offline over a large variety of media.

In practice, there are already known methods, such as for example those on the field of holding auctions in a communication net. As an example, we would like to refer to DE 102 25 111 A1. Concretely, from this publication there are methods known for holding online auctions between a number of bidders aiming at buying an auction item in form of goods or a service offered by a seller. For this purpose a communication net is offered via a computer system wherein the auctioneer reveals information via servers about the auction's object, the seller, the bidders as well as about the course of the auction. In this case it is absolutely mandatory that the bidders intervene into the communication net via a computer and by these means participate in the auction or at least retrieve information about the course of the auction. Within a pre-set time-span for the auction, bids can be made wherein an auction module which is assigned to the server identifies the corresponding highest bid. It is pointed out there as a special feature that the computers of the online bidders are connected via a so-called auction portal of the server to the auction module wherein the auction portal lets the bid either not, immediately or lets it pass with delay, depending on the control of the server. This approach is meant to relieve the computer system—in any whatsoever way—as a whole.

For further examples, we would like to refer to the DE 102 35 420 A1 concerning a method to run an automatic reverse auction and to the DE 102 19 699 A1, also concerning a method to run an auction. The same is valid for the state of the art as set out in the EP 1 246 116 A1, according to which a corresponding method is also known.

An auction process run over the Internet, which is in practice widely known, is offered by e-Bay. There, objects or services are offered for sale by means of an auction, wherein the interested people or potential participants are provided only restricted information. A dynamic initiation of the communication as possible there is not provided. In addition, the communication cannot or can only to a limited extent be influenced by the participants, i.e. by a concrete offer. Therefore, an interactive group communication does not take place. After all, the participants have only one possibility to take part in the auction, i.e. via Internet over a PC.

All of the above mentioned methods have the disadvantage that the communication is mainly unilateral and that a dynamic initiation is not possible. Insofar, the conditions for the communication are more or less pre-defined in a fixed way. This does not match the real requirement for the target of an interactive group communication which should be applicable in many ways.

### SUMMARY OF THE INVENTION

An object of the present invention is to provide a method for a dynamically initialized interactive group communication between several participants in such a way that it is universally applicable at a maximum of flexibility regarding the offered process. The target flexibility refers to the definition of the process itself on the one hand, and to the conditions for displaying and performing the process on the other hand, both of the latter shall be influenceable by the organizer as well as by the participants.

According to the invention, the above mentioned problem is solved by the characteristics of patent claim 1. According to this, by the method for a dynamically initialized interactive group communication between several participants regarding a process as offered by an organizer, the following process steps are realized.

First of all, the process is defined and conditioned, i.e. by the aid of process parameters freely definable by the organizer. So, the process can for example be a mobile auction being offered online via the portal “Internet” or any other mobile resources.

The resource or the resources to display the process and to offer the process or the participation in the process respectively are selected in any way.

In a further step, target persons or target groups are defined by the organizer and asked to participate or to register. The participation or the registration can be restricted to specific persons or person subgroups, as for examples to such persons having a specific authorization in the sense of being eligible.

After this, the interested persons register themselves whereby a selection for the participation takes place according to the definition of target persons or target groups. Accordingly, the registration is accepted or refused and the participants' group is defined due to criteria that can be set by the organizer. It is to be noted here that criteria also can develop in a dynamical way, i.e. taking the characteristics of registering persons as a basis. In this sense, a dynamic access authorization can evolve.

In a next step the interactive communication starts wherein this can take place in the framework of some kind of pre-phase. The start depends on the organizer, on one or more participants or on an event, so even in this stage a dynamic process can be considered.

In a further step it is possible to define process contents or to pre-set them. This process step can also be done at an earlier moment or can be done at any time during a later phase. After this, the interactive communication is performed with regard to the communication rules as pre-settable and if applicable, influenceable by the organizer, wherein these communication rules only define the framework of the communication. Besides, the parameters can be dynamically defined and/or changed here as well.

Furthermore, the communication can be finished after having achieved a defined event or after having achieved an event which can be defined or influenced in the course of the communication by one or more participants.

Concerning the characteristics described above, it should be noted that here in fact a dynamical initialization of the group communication takes place, regarding the process itself, the performance of the process as well as its end. In this sense, the start of the process as well as its performance and finally its end can be defined or performed depending on conditions. Important parameters resulting from the above mentioned characteristics are the status regarding the process, the presence or availability of the participants as well as the behavior of the participants all over the process.

The dynamically interactive phase of the process can be performed in real-time on the fixed network as well as by mobile means whereby a translation between the different media will be performed. Interactive multi-media communication services as for example PoC (push to talk over cellular) can be used in the framework of a mobile application. In this case it is essential though that also by using different media some kind of “translation” between the media takes place, so independently from the type of media participation in the communication is possible.

In an especially advantageous way the communication divides into a preparing phase—in the following to be referred to as preparation phase—and into a communicative operation phase which can preferably be initiated dynamically. The example of an auction taken, the preparation phase is the phase which is there called pre-bidding phase and the communicative operation phase, which can be initiated dynamically, is the actual bidding phase. It should be noted here that the transition between the two phases is smooth, i.e. depending on the freely definable parameters.

The transition between the two phases can be pre-defined or influenced by the organizer and/or one or more participants, so the beginning of the actual bidding phase can freely be defined, i.e. depending on the behavior of the organizer and/or the participants or depending on any other occurring situation respectively.

Concretely, the border between the two phases can be influenced, relating to the situation or to the context, i.e. depending on external conditions.

As mentioned before, the participants or the participant groups can be selected according to pre-definable selection criteria and/or according to the access resources as selected by or as accessible for the registering persons. It can be envisioned that only participants will be selectable being members of a pre-definable group of age, of a specific gender or depending on a context which can be retrieved or which can be indicated by the participants. It could also be defined that the access only takes place via Internet over PCs or via conventional mobiles. Any other criteria can be envisioned.

Within the preparation phase, the process itself as well as the process parameters can be influenced. For example, the start of the process can be defined or it can be initiated depending on occurring situations or states.

Within the operation phase, the course of this phase can be influenced by the organizer as well as by the participants, depending on the pre-settings of the organizer.

Furthermore, it is essential that the participants can retrieve information about the process, preferably status information. The retrieval of such information can be guaranteed at any time wherein in this case separate access authorizations or participation authorizations can be assigned.

Furthermore, it is advantageous if participants can retrieve context information, process-related information and/or information about other participants. An optimal availability of information would be guaranteed by these means, even though restrictions are also possible here.

It has already been described above that the participants can not only participate in the operation phase by a fixed station, as for example a PC, but also by mobile terminals. Here, an online-mode is possible as well as an offline-mode, according to the wish of the participants. Furthermore it is possible that a concrete medium for participation or for the selection of media for participation can be pre-set by the organizer, so the group of the participants is defined or correspondingly restricted by these means.

As a matter of principle, in the framework of the method as according to the invention it is possible that the access resource can be freely chosen by the participants and that a translation or mediation between the different media respectively takes place automatically. A restriction chosen by the organizer does not oppose to this basic selection.

Once again, it is to be pointed out that the communication process as described here can be any kind of process where a dynamic initiation of an interactive group communication is required. So, the process can for example be an auction, wherein the preparation phase is represented by the pre-bidding phase to prepare the bidding and the operation phase is represented by the bidding phase. The transition between the two phases can be shifted depending on parameters or events.

In the following, the method according to the invention will be described by the example of an auction, wherein auction-specific problems will be mentioned there and corresponding characteristics will be discussed.

Online Auctions are a well-known application in today's internet world for selling and buying private items to other people using a bidding process. The regular scenario is given by an online auction shop which advertises the auction items and final timing for the bidding until the auction closes. The winner of the highest bid will be informed. There are open question of server overload, real-time update of highest bid and a high bid rate towards the end of the auction process.

The process also mainly involves, that people are online in order to participate or a pre-upload of bids could also be realized. All these variations available today lack the dynamics in their auction settings and process conditions. Besides including live (in-person) auction portions into auctions, which are carried out on certain places, a direct personal interaction between seller and the potential buyers are not given. Preferences from the seller (e.g. who is permitted to bid, or can the final bidding be performed when the seller is online and could he restrict it to people who have been sent a pre-bid already) and from the potential buyer (e.g. notify only, when item also supports PoC final bidding option) are not considered yet.

The invention proposes a unique auction system which integrates the dynamics and fun of personal interaction with the participants of the auction by utilizing interactive multimedia communication services (e.g. Instant messaging, PoC) in the final bidding scenario. In addition, the flexibility of IMS services in their dynamic choice of different media is utilized and applied for the bidding as well as the recording process. The preparation phase of the auction is enhanced by including presence features in the auction announcement and publication process (using a dynamic agenda with subscription support), as well as during the different auction phases as defined in this invention.

The proposed invention proposes a new way of communication, applicable for mobile auction scenarios by including dynamic context adaptation for communication means. The presented solution includes dynamic scenarios for offline process during the bidding preparation and pre-bidding phase and a dynamically initiated interactive communication during the real bidding phase. These processes are influenced by means of presence, context (e.g. terminal capabilities, accept/reject lists, user parameter, ratings), and user policy settings. The interactive communication process offers free media choice, mandates recording capabilities for any offered media into a generalized process logging protocol. During the auction preparation, we propose the usage of presence functions (e.g. watching, notifications) on auction groups and items, as well as the auction agenda dynamically assigned by parameters like auction item kind, time, or auction seller.

### BRIEF DESCRIPTION OF THE DRAWINGS

FIG. 1 is a block diagram showing an online auction system based on context-based initiation of auction communication according to an embodiment of the present invention; and

FIG. 2 is a diagram showing the business process model for the auction system according to the embodiment of the present invention.

### DESCRIPTION OF THE PREFERRED EMBODIMENT

Auction System

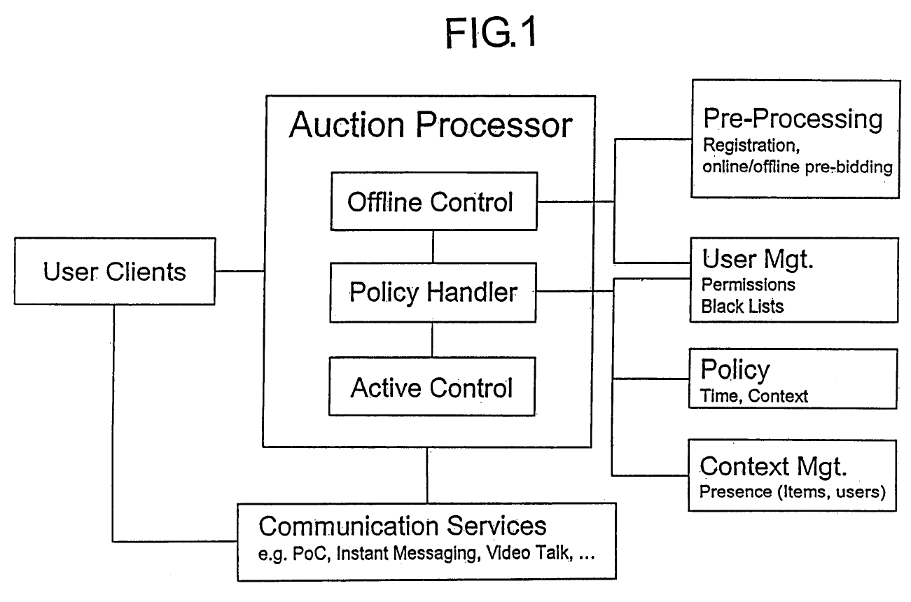

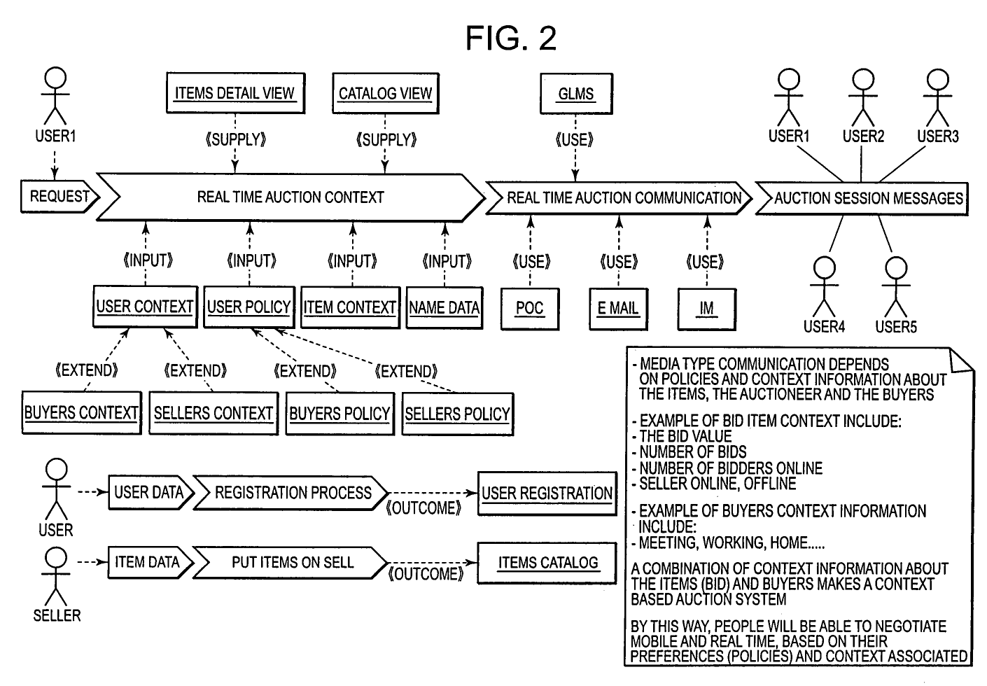

FIG. 1 shows a system according to an embodiment of the present invention. FIG. 2 shows the steps from the auction registration and initiation, over the context collection (e.g. user context, catalog details and item context) up to the auction communication phase (e.g. PoC, instant message, email).

The online auction is divided into the pre-bidding phase and dynamical interactive final bidding phase. The pre-bidding phase is given as an offline process, organized by website-access, SMS and Email communication. The final bidding phase is characterized by an interactive communication. The auction processor is the main module for the control of pre-bidding and interactive auction phase. The core of the auction processor is the policy handler which interacts with the user manager and context controller in order to control the setup and sessions for both auction phases.

It is proposed an auction system integrating context-driven control which is defining the pre-bidding phase as well as the process of interactive bidding process. The context-based policies are defined by considering
permissions (e.g. registration, user groups, black lists/white lists settings)
time settings
preferences of seller and bidding community (e.g. in service selection)
context settings like presence and terminal/network capabilities
   a) Auction Status and Preparation

The preparation of an auction process is characterized by the publishing of the item to be sold and the conditions in pricing, and the time for the auction to be closed.

This invention includes specifically two new features during the auction preparation:
Auction Agenda: The Agenda is a sorted list or table, in order to display the auction items in means of kind of item, time to sell, seller, interest in auction item groups and any other sorting possibilities. The list shall also be organized in a hierarchical way displaying the status (presence) of the auction items and—if already in waiting or auction room—the highest bid currently set.
Presence of published auction items: Auction Items, go through a process of phases in order to gain a significant number of people for the final bidding process. During this process, the items are based in different states to reflect their current auction phase. The states might be defined as
   “published”: the auction item is published and description information is available. Interested people can be notified via their interest preferences for open subscription on the item. After subscription to the status of that item, potential buyers get notification of the status and possible also the current highest bid for the item.
   “waiting room”: The auction item is placed in the waiting room. This state means that the item is visible in the agenda, the pre-bidding phase is opened. This state is the non-real-time, non-interactive process, where pre-bid values can be submitted.
   “auction room”: The auction item is placed into the interactive communication status. Depending on the selected media or media combination, the auction room is real-time (e.g. PoC) or a combination of non- and real-time media.
   “closed”: The final bidding scenario has been done and the auction on the selected item is closed. The wining bid value as well as the winner might be displayed, depending on the preferences of seller and auction winner.
Notification: Users (acting as buyer as well as seller) can subscribe to be notified about the status change of any item they want to know about. The notifications include status change but also highest bid value, number of eligible users for auction room, etc. For the detailed notification mechanism, various filter techniques (e.g. in timing, bid limits, etc) can be applied. The possibility to subscribe to the status of the auction item can be restricted by the seller's preferences about the final bidding group.
   b) Pre-Bidding Phase

The waiting room is an open group of potential buyers. The room can be joined by any user depending of permission granted. The permission is based on joining settings of the seller of the item. These settings can be based on e.g. bidding history of potential buyer, reject/accept lists, timing, preferences for final bid phase (e.g. accept with PoC-capability only), size of final bidding group in auction room. Potential buyers who have subscribed to that item are notified of the waiting room state and are granted to join the waiting room. Joining the waiting room and/or submitting a valid bid value include the automatic sign-up for the dynamic auction room phase. Joining the waiting room also informs the subscriber about the preferences and settings for the auction room, where the final bidding will be hold. Conflicts between the seller's preferences (e.g. prefers only PoC communication) with the subscriber's settings (e.g. no PoC support given) are informed to the subscriber.

c) Interactive Auction Phase

The auction room is the implication of the interactive communication phase, given by a pre-defined group of the seller and the potential buyers. The group of buyers is generated of the users who got granted the permission based on their subscription to the waiting room and their bidding history on the selected item, or by preferences of the seller. The preferences of the seller for the auction room are informed to the subscriber during joining of the waiting or auction room. The auction group (so-called bidder community) might be governed in several ways:
Registration for late-bidding phase (e.g. based on bid-value, presence of participants, etc.)
Requirement for participation in waiting room
Requirements on re-joining or late-joining

The auction room supports single-media (e.g. PoC only) as well as mixed-media selection (e.g. PoC and text chatting). The auction room is generated and populated with the users based on context-driven policy decisions. The waiting room will be closed then.

d) Participation Control

The users of the auction service (independent of their role in a specific auction to act as seller or buyer) are given the possibility to store accept or reject lists (so-called Black Lists) in order to control who is involved in the auction they are participating. The user can also specify filter settings for auction setup notification (acting as potential buyer) or for auction participant acceptance (acting as seller).

Interactive Communication

a) Initiation:

The auction room is initiated based on single or any combination of the following reasons:
Time preferences of seller
Presence of seller and potential buyers
Specific target value reached in the pre-bidding process
Maximum number of interactively-permitted buyers reached.

A possible scenario is the initiation of a PoC bidding session including the seller and all these potential buyers, who are currently present and PoC session available and are under the 10 highest bids from the waiting room phase.

As a special communication selection, we propose the choice of PoC-based auction room with dedicated dispatcher mode for automatic floor control of bidders.

b) Media Selection:

In an open scenario (this means not restricted by any media preferences of the seller), the system does support free media choice for all participants in the auction room phase. The selection of the media is in a context-aware environment respecting the means of preferences, presence and terminal settings for the supported media. As an example: a user with his preference settings in media choice for PoC (1^{st} priority) and Instant Messaging (IM) (2^{nd} priority) is joining the auction room phase automatically by the presence settings. The user is currently involved in an active PoC session and cannot accept a 2nd PoC session in parallel. The auction control is automatically initiating the IM session for this user, accepting his second priority in media choice.

The media integration of mixed media selection is based on timing control on lowest latency restrictions. The “Active Control” module is responsible for the support of proper bid queue moderation and recording for the different media.

c) Auction Moderation:

The auction room is controlled by an electronic and automatic bidding queue control. The queue control is based on the receiving of the bid on its original media (e.g. voice, text, video). The re-queuing of the buyers is managed in number (e.g. limited number of bid vouchers inside the auction room), frequency (e.g. bidding permitted after. ⅓ of the group has also given their bid values), rating and ordering of bid values (e.g. the order of bids of different participants cannot be repeated twice in order to avoid pricing push or dumping in some way). As a special queued control scenario we propose the PoC-hosted auction room in PoC dispatcher mode whereby the dispatcher might be the seller or a personal or electronic auctioneer.

d) Recording:

The auction room involves different media for the bidding on the selected item. The recording guarantees the proof of the bidding session. For this, we propose the “Active Control” module to perform the media transformer and logging module of the auction processor, which includes the following:
Real-time interpretation of bid values given in voice-based services by voice recognition
Real-time interpretation of bid values given in text-based services by text recognition
Real-time interpretation of bid values given in image-based services by image recognition
Transforming of the values to/from voice from/to text
Transforming of the values from video to text/voice

The recording of the bidding session is done in a generalized bidding protocol based on the settings of the seller (e.g. preferences are set to text-based protocol). This protocol is accompanied by the media-original recording logs, which means there are number of media-specific protocols as media has been involved in a given bidding session.

e) Announcement on Current Bid Status/Value

The information about the latest/highest bid will be announced constantly to interested parties. In addition to the display of the information on the auction room bullet on the website, our invention includes the simultaneous interactive sessions in order to permit automatic announcement for the interactive session mode. The invention specifically includes:
Announcement in simultaneous session support of same communication kind (e.g. active PoC session for bidding, announcement in PoC alert or simultaneous PoC session (as voice or transformed in text)
Announcement in simultaneous session support of mixed interactive communications (e.g. interactive sessions in PoC, announcements via IM)
Announcement in simultaneous session support of interactive and offline communications (e.g. interactive sessions in PoC/IM, announcements via SMS/Email)

The key features of the inventions regarding auctions are in the topics for:

(1) Initiating Communication/Messaging Session After Completion of Pre-Bidding Process

a) Pre-bidding limits are conditioned by settings in time, minimum pricing, size of final bidding community, etc.
b) Initiation of Communication session (e.g. voice, text, video)
c) Special: Initiation of PoC session as specific voice communication
d) Permission-based bidding community (e.g. registration for late bidding, pre-bidding required, bidder status club with various joining permissions)
   (2) Media Selection:
a) Media-type access control for auction performance by
   allowing fast media only
   introduction of artificial delays to cope with slow media selections
   prioritizing media by bidding history
b) Context/policy-based media selection for each user (bidder/seller)
   (3) Bidding Rooms with Various Permissions During Auction Assignment (Alerts, Late-Bidding, Late-Joining, Initial-Bid-Request, Etc.)
a) Waiting Rooms for pre-bidding process (e.g. Chat rooms)
b) Auction Rooms for final bidding process (e.g. Chat rooms, predefined/ad hoc PoC groups)
   (4) Participant Handling:
a) Black List/White List control
b) Context-based/history-based rejection lists (bidder rating, bidder/seller history)
   (5) Auction Moderation Including Queuing Control:
a) Auction Moderator (electronic, Automatic control)
b) Communication session queued control: permission of queuing control in bidding process for seller and purchaser
c) Special: PoC session queued control in arbitrary or dispatcher mode
d) re-queuing control in number, frequency, rating (for avoiding price dumping in any direction)
   (6) Recording/Bidding Value Tracking and Control:
a) bid extraction by image recognition
b) bid extraction by voice recognition
c) bid extraction by text recognition
d) Real-time interpretation of the bids from/to voice to/from text
e) Real-time interpretation of the bids from video to text/voice
   (7) Simultaneous Bid Display:
a) simultaneous PoC session into text mode or simultaneous messaging session permits online visualization of highest bid (text roll on terminal)
b) simultaneous history, presence and bid values analysis, with dynamic sub-grouping of highest bidding group
c) simultaneous PoC session handling for multiple bidding scenarios
   (8) Auction Preparation:
a) Notifications/Watching of bid item's status/process using Presence
b) Auction Item groups: notification of new items
   (9) Auction Agenda:
a) Overview of auction items, sorting by time, kind of items, etc.
b) Hierarchical agenda listing with presence status of auction items (e.g. published, in waiting room, in auction room, closed)
   The major features regarding auctions are:
   1. Standard auction (optional phase)
   1.1 Context Integration
   1.1.1 Presence Information
   1.1.1.1 Participant Presence;

Including, but not limited to: availability, media types (services)

1.1.1.2 Product presence;

Including, not limited to:
a) Status: standard auction phase
b) Status: enhanced auction phase
c) number of on-line participants
d) number of on-line participants per communication service type
   1.1.2 Notification

Participant/product presence change notification based on participant preferences

1.2 Initiation of dynamic interactive phase

1.2.1 Automatic trigger:

based on context conditions or pre-arranged to a certain time

1.2.2 Manual: determined by the moderator

1.3 Participant Access control to the auction based on acceptance/rejections management mechanism and/or preference control list system

2. Dynamic interactive (final) auction

2.1 Media types

2.1.1 Multiple media co-existence mode (integrating real-time and non-real-time communication services; chat, voice (VoIP), video, POC, email, SMS, etc. . . . )

2.1.2 Unique media mode:

Enforces the use of a given media depending on auction preferences and bidding history

2.2 Participant Access control to the enhanced auction, which allows for late joining and re-joining

2.3 Context Integration

2.3.1 Participant presence;

Including but not limited to availability, bidding statistics, media capabilities
   2.3.2 Product presence/status;

Including but not limited to status, bidding statistics, highest offered price

2.3.3 Notifications

Participant/product presence change notification based on participant preferences incl.

2.4 Highest bid display using translation when in multi-media mode

2.5 Flexible auction ending.

Optional delayed ending takes media types into consideration before ending the auction.

The examples of an embodiment related to the auction as described above only serve as a mere exemplary illustration of the claimed teaching, but do not restrict the latter to auction-specific methods at all.

1. A method for dynamically initiated interactive group communication between several participants regarding a process offered by an organizer, comprising:
definition and conditioning of the process according to parameters that can freely be defined by the organizer;
selection of the resource or the resources to display the process;
definition of target persons or target groups and call by the organizer for participation/registration;
registration by interested persons;
acceptance of the registration and definition of group of participants according to criteria which can be pre-set by the organizer;
start of the interactive communication depending on the organizer, on one or more participants or on an event;
specification of a process content;
enforcement of the interactive communication with regard to the communication rules that can be pre-set and—if applicable—influenced by the organizer; and
completion of the communication when reaching a result which is defined or which can be defined or influenced by the organizer or by one or more participants in the course of the communication.

2. The method according to claim 1, further comprising:
a preparation phase preparing the interactive communication; and
a communicative operation phase which can preferably be initiated in a dynamic way.

3. The method according to claim 2, wherein the transition between the two phases can be pre-set or influenced by the organizer or by one or more participants.

4. The method according to claim 2, wherein the transition between the two phases can be influenced according to a situation or a context, i.e. depending on external conditions.

5. The method according to claim 1, wherein the participants can be selected according to pre-definable selection criteria and/or according to access resources that are available to and selected by the registering persons.

6. The method according to claim 1, wherein the process and thus the process parameters can be influenced during the preparation phase.

7. The method according to claim 1, wherein during the operation phase, the course of this phase can be influenced by the organizer as well as by the participants.

8. The method according to claim 1, wherein the participants can retrieve information about the process, preferably status information.

9. The method according to claim 1, wherein the participants can retrieve context information, process-related information and/or information about other participants.

10. The method according to claim 1, wherein the participants can participate in the preparation and/or operation phase via mobile terminals.

11. The method according to claim 1, wherein the organizer can pre-set a concrete medium or a selection of media for participation.

12. The method according to claim 1, wherein the access resource can freely be chosen by the participants and that an automatic translation between different media takes place.

13. The method according to claim 1, wherein the process is an auction.

14. The method according to claim 13, wherein the preparation phase is the pre-bidding phase to prepare bidding, and that the operation phase is the bidding phase.
